(19) United States
(12) Patent Application Publication
(10) Pub. No.: US 2025/0033960 A1
(43) Pub. Date: Jan. 30, 2025

(54) INTEGRATION OF STEAM CRACKER AND BLUE HYDROGEN UNITS TO REDUCE CO2 EMISSION

(71) Applicants: Rian Reyneke, Katy, TX (US); Paul Richard Langston, Middlesex (GB)

(72) Inventors: Rian Reyneke, Katy, TX (US); Paul Richard Langston, Middlesex (GB)

(73) Assignee: KELLOGG BROWN & ROOT LLC, Houston, TX (US)

(21) Appl. No.: 18/783,299

(22) Filed: Jul. 24, 2024

Related U.S. Application Data
(60) Provisional application No. 63/515,295, filed on Jul. 24, 2023.
(60) Provisional application No. 63/581,586, filed on Sep. 8, 2023.

(51) Int. Cl. C01B 3/36; C01B 3/50; C10G 9/36; C10G 70/04

(52) U.S. Cl. CPC C01B 3/36; C01B 3/50; C10G 9/36; C10G 70/04; C01B 2203/0216; C01B 2203/042; C01B 2203/063; C01B 2203/0822; C01B 2203/0827; C01B 2203/1241; C01B 2203/84; C01B 2203/86; C10G 2300/4043; C10G 2300/42

(57) ABSTRACT

A process and system for integrating a steam cracking unit with a blue hydrogen unit in which a methane-rich gas stream, a hydrogen-rich gas stream, or both from the steam cracking unit are fed to the blue hydrogen unit and a high purity hydrogen gas stream from the blue hydrogen unit is directed to the steam cracking unit.

This application claims the benefit of U.S. Provisional Application No. 63/515,295, filed Jul. 24, 2023, and U.S. Provisional Application No. 63/581,586, filed Sep. 8, 2023, both of which are incorporated herein by reference in their entirety.

### FIELD OF THE INVENTION

The present invention relates to a system and method for the integration of steam cracking unit and blue hydrogen units to reduce CO2 emission.

### BACKGROUND

Olefin production generally involves steam cracking, a process that can be very energy intensive and contributes substantially to global CO2 emissions. The primary source of direct CO2 emission is the cracking furnaces, where fuel gas is burned to provide the heat required for net process heating, to satisfy the cracking heat of reaction (endothermic reaction) and where waste heat is used to generate steam.

Fuel gas used in steam cracking units can contain as high as 80-85 mol % H2 in ethane crackers, or as low as 10-15 mol % in liquid crackers, with the remainder being mostly methane. Combustion of hydrogen has no associated CO2 emission, while combustion of methane produced approximately 230 kg CO2/Gcal of fired duty.

In typical steam cracking units, combustion air enters the furnace without being preheated. With cold combustion air, a substantial portion of the fired duty is required simply to heat up the combustion air to combustion temperature, with associated CO2 emissions. This produces a relatively large flue gas stream that is then used to provide the net heat for feed preheat and superheated high pressure (SHP) steam generation.

### SUMMARY OF THE INVENTION

Exemplary embodiments of an integration of steam cracking unit and blue hydrogen units to reduce CO2 emission that can substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In examples, a system may include a steam cracking unit; a blue hydrogen unit including a hydrogen recovery system configured to generate a high purity hydrogen gas stream; a first conduit configured to direct at least a portion of the high purity hydrogen gas stream to the steam cracking unit to be used as fuel; and a second conduit configured to direct at least a portion of a methane-rich gas stream from the steam cracking unit to the blue hydrogen unit.

In examples, the steam cracking unit may include a cracking furnace and a recovery stage configured to recovery the methane-rich gas stream from an effluent gas of the cracking furnace of the steam cracking unit. In examples, the system may include a second conduit configured to direct at least a portion of the methane-rich gas stream to the blue hydrogen unit to be used as feed, fuel, or both.

In examples, the system may include a compressor configured to compress at least a portion of the methane-rich gas stream prior to reaching the blue hydrogen unit.

In examples, the system may include a recovery stage as part of the steam cracking unit configured to receive an effluent from a cracking furnace and separate from the effluent at least a hydrogen-rich gas stream and a methane-rich gas stream; and a third conduit configured to transfer at least a portion of the hydrogen-rich gas stream from the recovery stage to the hydrogen recovery system of the blue hydrogen unit.

In examples, the system may include a gas expander for expanding the high purity hydrogen gas stream before it reaches the steam cracking unit.

In examples, the system may include a heater for preheating the high purity hydrogen gas stream before it reaches the gas expander.

In examples, the system may include a compressor configured to compress at least a portion of the methane-rich gas stream prior to reaching the blue hydrogen unit, wherein an energy recovered by the gas expander is employed to power the compressor.

In examples, a process may include generating a high purity hydrogen gas stream in a blue hydrogen unit including a hydrogen recovery system; feeding the high purity hydrogen gas stream to a steam cracking unit as fuel; and directing a methane-rich gas stream from the steam cracking unit to the blue hydrogen unit.

In examples, the process may include recovering the methane-rich gas stream from an effluent of the steam cracking unit; and directing the methane-rich gas stream to the blue hydrogen unit as feed, fuel, or both.

In examples, the steam cracking unit may include a cracking furnace. In examples, the process may include recovering a hydrogen-rich gas stream from the tail gas of the cracking furnace of the steam cracking unit; and transferring at least a portion of the recovered hydrogen-rich gas stream to the hydrogen recovery system of the blue hydrogen unit.

In examples, the process may include compressing the methane-rich gas stream prior to directing the methane-rich gas stream to the blue hydrogen unit.

In examples, the process may include expanding the high purity hydrogen gas stream before feeding the high purity hydrogen rich gas to the steam cracking unit.

In examples, the process may include preheating the high purity hydrogen gas stream before expanding it.

In examples, the process may include recovering energy when expanding the high purity hydrogen gas stream.

In examples, the process may include compressing a methane-rich gas stream from the steam cracking unit using a compressor and powering said compressor with the energy recovered from expanding the high purity hydrogen gas stream prior to directing the methane-rich gas stream to the blue hydrogen unit.

In examples, the steam cracking unit may include a cracking furnace and the process may include preheating a combustion air used as fuel in a cracking furnace of the steam cracking unit.

In examples, the steam cracking unit may include a cracking furnace and the process may include preheating a feed to a cracking furnace of the steam cracking unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of an example of the integrated steam cracking unit with the blue hydrogen unit.

FIG. 2 is a schematic view of an example cracking furnace of a steam cracking unit that may be used in the integration system described.

FIG. 3 is a schematic view of another example of a cracking furnace of a steam cracking unit that may be used in the integration system described.

FIG. 4 is a schematic view of an example recovery system of a steam cracking unit that may be used in the integration system described.

### DETAILED DESCRIPTION

In examples, a process and system are disclosed to integrate a steam cracking unit with a hydrogen unit. In examples, the hydrogen unit is a blue hydrogen unit. For purposes of this disclosure, the term “blue hydrogen unit” is used to refer to a unit (or facility or system) that produces hydrogen through steam methane reforming (SMR) while also capturing and storing the carbon dioxide (CO2) emissions generated during the production process. In examples, the process and system as disclosed may achieve a low or zero CO2 emission through integration of the steam cracking unit with a blue hydrogen unit.

In examples, the steam cracking unit may include an olefin unit configured to produce one or more olefins through the thermal cracking of hydrocarbon feedstocks, such as for example, naphtha, ethane, propane, or butane, in the presence of steam. In examples, the high-temperature and high-pressure process can break down larger hydrocarbon molecules into smaller ones, primarily ethylene and propylene. In examples, olefins may be used in various industrial applications.

Recovery of hydrogen from the effluent gas of a cracking furnace of a steam cracking unit may be performed but often may be limited in the level of purity that it may generate. Hydrogen may be recovered in a steam cracking unit via a crude separation of the effluent product. In examples, the separation can separate out the olefin from the hydrogen and methane effluents. In examples, further separation may lead to a hydrogen rich stream and a methane rich stream. In examples, the separation of hydrogen and methane may be carried out in a cold box to produce a high-pressure hydrogen-rich gas stream with purity of approximately 90-95 mol %, and a low-pressure methane-rich gas stream that is usually used as fuel gas. A portion of the hydrogen-rich gas stream can be injected into the methane-rich gas stream to achieve the necessary temperature driving force in the cold box to achieve the cooling and separation. As a result, the recovery of available hydrogen may be limited to approximately 80-85%.

Although this system may lower carbon emission, it may not be sufficient to achieve desired results.

To address some of these problems, disclosed herein is a process and system in which the steam cracking unit, or olefin unit, is integrated with a blue hydrogen unit. In examples, the integration may be configured such that the tail gas from the steam cracking unit may be used as feed to the blue hydrogen unit. In examples, the integration may be configured such that the blue hydrogen unit can be employed to achieve higher hydrogen concentration in the hydrogen-rich gas stream separated from the effluent gas of the cracking furnace of the steam cracking unit. In examples, the integration may be configured such that additional hydrogen is provided to the steam cracking unit to supplement and/or replace the hydrogen-rich gas stream.

Reducing CO2 emissions has become a key factor in evaluating project or technology viability. In examples, the system and process as described herein can provides an effective way to achieve net zero carbon emissions, with potential for significant environmental and economic benefits.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

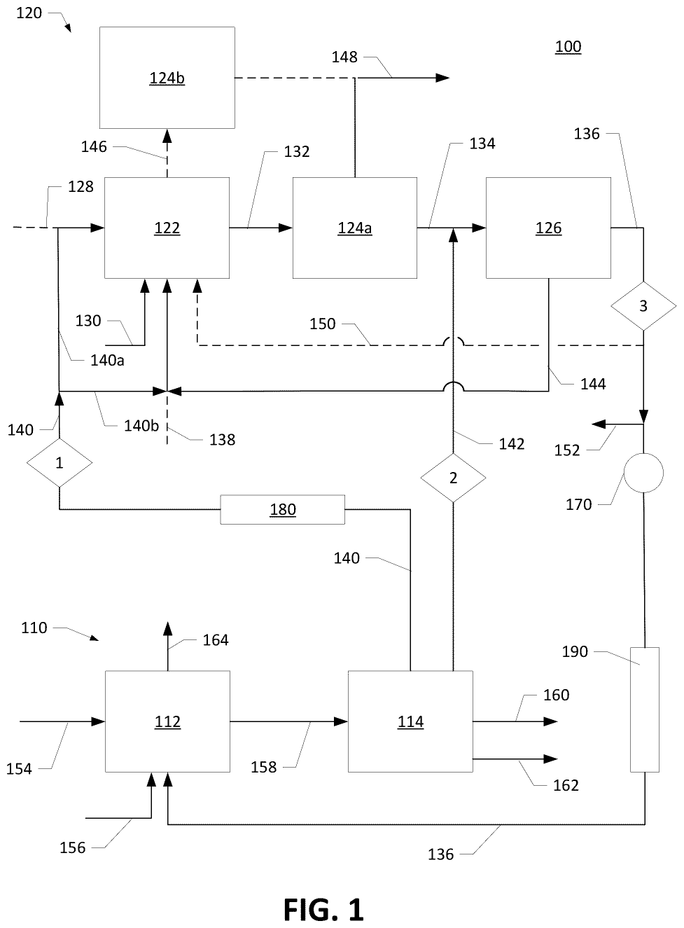

FIG. 1 illustrates a diagram of an integration scheme between a steam cracking unit and a blue hydrogen unit. In examples, as illustrated in FIG. 1, the process and system disclosed herein use external high purity hydrogen as generated in a blue hydrogen unit as fuel to the cracking furnace of the steam cracking unit, with the goal of achieving net zero emission in the steam cracking unit. In examples, the process and system disclosed herein can use supplemental hydrogen from a blue hydrogen unit to reduce carbon emissions in the steam cracking unit (potentially all the way to net zero emission).

In examples, as shown in FIG. 1, the integration process and system 100 can integrate a steam cracking unit 110 with a blue hydrogen unit 120. In examples, the integration process and system 100 may include a steam cracking unit 110 in fluid communication with a blue hydrogen unit 120. In examples, the integration 100 of steam cracking unit 110 and blue hydrogen unit 120 may be achieved by feeding a methane-rich effluent stream from the steam cracking unit 110 to the blue hydrogen unit 120. In examples, the integration 100 of steam cracking unit 110 and blue hydrogen unit 120 may be achieved by employing a methane-rich effluent stream from the steam cracking unit 110 as fuel for the blue hydrogen unit 120. In examples, the integration 100 of steam cracking unit 110 and blue hydrogen unit 120 may be achieved by employing a high purity hydrogen gas stream from the blue hydrogen unit 120 as fuel for the steam cracking unit 110. In examples, the integration 100 may include employing the blue hydrogen unit 120 to purify at least a portion of a hydrogen-rich effluent stream of the steam cracking unit 110.

In examples, the steam cracking unit 110 may include a cracking furnace 112. In examples, the steam cracking unit 110 may include a recovery system 114.

The blue hydrogen unit 120 may be configured in different manners while still achieving the benefits of the invention. For purpose of this description, FIG. 1 illustrates one implementation of the blue hydrogen unit 120 and its integration with a steam cracking unit 110. In examples, as illustrated in FIG. 1, the blue hydrogen unit 120 may include a hydrogen synthesis system 122, one or more carbon capture system 124 (e.g. 124a and 124b), and a hydrogen recovery system 126.

In examples, a blue hydrogen unit may involve the production of hydrogen from natural gas hydrocarbon such as methane using steam methane reforming (SMR) technology. In examples, the blue hydrogen unit may also include a carbon capture and storage (CCS) system to mitigate the carbon emissions associated with the process.

As shown in FIG. 1, the blue hydrogen unit 120 may include a natural gas feed 128. In examples, the natural gas feed 128 may include methane (CH4). In examples, the natural gas or methane can serve as a source of hydrogen in the blue hydrogen production process.

In examples, the natural gas feed 128 is provided to the hydrogen synthesis system 122. In examples, a hydrogen synthesis system 122 may include a hydrogen generator or steam methane reformer. In examples, a steam feed 130 is also provided to the hydrogen synthesis system 122. In examples, during steam methane reforming the natural gas hydrocarbon or methane feed may be reacted with steam (H2O). In examples, the reaction may be carried out at high temperatures, for example, between about 700° C. and 1,000° C., and under pressure. In examples, the heating for the hydrogen synthesis system 122 may be provided by electric means and/or by burning a fuel stream 138.

In examples, the steam methane reforming process can produce hydrogen gas (H2) and carbon monoxide (CO) through a series of chemical reactions. For example, in an initial step, the hydrocarbon or methane can react with the water molecule in steam to yield a carbon monoxide and hydrogen as illustrated by equation (1):

CH4+H2O→CO+3H2 (1)

In examples, the carbon monoxide produced in this step may be further reacted with steam to generate additional hydrogen and carbon dioxide as illustrated by equation (2):

CO+H2O→CO2+H2 (2)

In examples, the blue hydrogen unit may include one or more carbon capture systems 124. In examples, one or more carbon capture systems 124 may be employed to remove the carbon dioxide generated during the SMR from effluent stream 132 of the hydrogen synthesis system 122. In examples, one or more carbon capture systems 124 may be employed to capture carbon from burning fuel to heat the hydrogen synthesis system 122.

In examples, the carbon capture process may involve separating the CO2 from the hydrogen and other gases produced in the reforming process. Various technologies, such as absorption, adsorption, and membrane separation, can be used for this purpose. In examples, a carbon capture system 124 may include any equipment suitable for any of these processes such as columns, rotating packed beds, separation membranes, or other equipment.

In examples, as shown in FIG. 1, the blue hydrogen unit 120 may include one or more carbon capture systems 124. For example, the blue hydrogen unit 120 may include a first carbon capture system 124a and a second carbon capture system 124b. In examples, the carbon capture system 124a may be configured to capture the carbon dioxide form the effluent of the hydrogen synthesis system 122.

In examples, another carbon capture system 124b may be configured to capture carbon from the flue gas stream 146 of the hydrogen synthesis system 122 produced by burning of hydrocarbons, such as methane, as fuel stream 138 to produce heat. In examples, the hydrogen synthesis system 122 may not use hydrocarbons such as methane in fuel stream 138 to produce heat. In such examples, the additional carbon capture system 124b may not be present. For example, fuel stream 138 to hydrogen synthesis system 122 may include pure hydrogen. In examples, fuel stream 138 may be supplied by a hydrogen stream produced by the blue hydrogen unit 120.

Once the CO2 is captured, it can be compressed and transported to a suitable geological storage site. The compressed CO2 may be transported as stream 148 to be stored in one or more storage reservoirs, such as depleted oil and gas fields or deep saline aquifers.

In examples, the effluent stream 134 from the carbon capture system 124a may be a hydrogen-rich gas stream. In examples, the effluent stream 134 may include a hydrogen concentration of about 95 mol % with the balance being methane and carbon oxide. In examples, not shown, a portion of effluent stream 134 may be used as or to supplement fuel stream 138 to the hydrogen synthesis system 122. In examples, not shown, a portion of effluent stream 134 may be combined with at least a portion of hydrogen-rich stream 142 and used as fuel for the cracking furnace 112 of the steam cracking unit 110. In this latter example, the hydrogen-rich stream 142 may or may not be injected into the blue hydrogen unit 120.

In examples, the hydrogen gas produced in the SMR process that is part of the hydrogen-rich effluent stream 134 may undergo purification. In examples, the hydrogen-rich effluent stream 134 from the carbon capture system 124a may be directed to one or more hydrogen recovery systems 126. In examples, a hydrogen recovery system 126 may include purification system. In examples, the hydrogen recovery system 126 may include a pressure swing adsorption (PSA) system or process, membrane separation, or any combination thereof. In examples, a hydrogen recovery system 126 may include a PSA as a purification system.

In examples, as illustrated in FIG. 1, the hydrogen recovery system 126 may include a PSA system or process. A PSA System may include one or more columns with one or more adsorbents. In examples, the hydrogen-rich effluent stream 134 from the carbon capture system 124a may include some impurities and/or carbon content. In examples, by passing the hydrogen-rich effluent stream 134 through the hydrogen recovery system 126 it may be possible to yield a high purity hydrogen gas stream 136 with a hydrogen concentration of >95 mol %, for example >98 mol %, for example about 98.5 mol % or greater, for example about >99 mol % or greater, for example about 99.5 mol % or greater, for example about 100 mol %.

In examples, high purity hydrogen gas stream 136 may be used in place of or to supplement fuel stream 138 to the hydrogen synthesis system 122. In examples, at least a portion of high purity hydrogen gas stream 136, e.g. stream 150, may be used as fuel for hydrogen synthesis system 122. In examples, at least a portion of high purity hydrogen gas stream 136 may be combined with the methane-rich gas stream 140 and used as fuel for hydrogen synthesis system 122. In examples, a portion of high purity hydrogen gas stream 136 may be directed to the hydrogen synthesis system 122 to be used as the only fuel for the hydrogen synthesis system 122.

In examples, the hydrogen recovery system 126, such as a PSA system, may include a tail gas 144. In examples, tail gas 144 may include methane. In examples, tail gas 144 may be directed to the hydrogen synthesis system 122 to be used as fuel. In examples, tail gas 144 may be combined with at least a portion of the high purity hydrogen gas stream 136 and/or methane-rich gas stream 140 to be used as fuel for the hydrogen synthesis system 122.

In examples, the integration of the steam cracking unit 110 with the blue hydrogen unit 120 may include feeding methane-rich gas from the steam cracking unit 110 to the blue hydrogen unit 120. In examples, the integration of the steam cracking unit 110 with the blue hydrogen unit 120 may include feeding hydrogen from the blue hydrogen unit 120 to the steam cracking unit 110. In examples, the integration of the steam cracking unit 110 with the blue hydrogen unit 120 may include feeding a hydrogen-rich gas stream from the steam cracking unit 110 to the blue hydrogen unit 120. In examples, integration of the steam cracking unit 110 with the blue hydrogen unit 120 may include a combination of two or more of these elements. In examples, the integration of the steam cracking unit 110 with the blue hydrogen unit 120 may include a combination of all of these elements.

In examples, the steam cracking unit 110 may include a recovery system 114. In examples, using recovery system 114 a process may be included to segregate methane-rich gas stream 140 (stream 1) and a hydrogen-rich gas stream 142 (stream 2). In examples, the recovery system 114 may be configured to recover internally-produced hydrogen from the effluent of cracking furnace 112. In examples, recovery of internally-produced hydrogen into the hydrogen-rich gas stream 142 may be maximized. In examples, recovery system 114 may yield a hydrogen-rich gas stream 142 that can include about 90 mol % to about 95 mol % hydrogen.

In examples, the integration may include sending at least a portion of methane-rich gas stream 140 to the blue hydrogen unit 120. In examples, at least a portion of methane-rich gas stream 140 may be directed to the hydrogen synthesis system 122. In example, the methane-rich gas stream 140, or portion thereof, may be combined with natural gas feed 128 and fed to the hydrogen synthesis system 122 for hydrogen production. In examples, the methane-rich gas stream 140, or portion thereof (e.g. 140a), may be fed to the hydrogen synthesis system 122 separate from but in the same manner as the natural gas feed 128. In examples, the methane-rich gas stream 140, or portion thereof, may be the only feed other than steam to the hydrogen synthesis system 122 for production hydrogen, without requiring a natural gas feed 128. In examples, the methane-rich gas stream 140, or portion thereof (e.g. 140b), may be used in place of or to supplement fuel stream 138 to the hydrogen synthesis system 122. In examples, a first portion 140a of the methane-rich gas stream 140 may be fed to the hydrogen synthesis system 122 to produce hydrogen together with natural gas feed 128, and a second portion 140b of the methane-rich gas stream 140 may be directed to the hydrogen synthesis system 122 to be used as or to supplement fuel stream 138 to heat hydrogen synthesis system 122. In examples, a larger portion of the methane-rich gas stream 140 may be fed to the hydrogen synthesis system 122 to produce hydrogen and a smaller portion of methane-rich gas stream 140 may be used as or to supplement fuel stream 138 to heat hydrogen synthesis system 122.

In examples, steam cracking unit 110 may be controlled such that the at least a portion of methane-rich gas stream 140 fed to the hydrogen synthesis system 122 to be used as hydrogen source to produce hydrogen may have a flow rate based on the amount of hydrogen produced by the blue hydrogen unit 120. In examples, the amount of methane-rich gas in methane-rich gas stream 140 may be fed to the hydrogen synthesis system 122 for hydrogen production in a ratio of approximately 3.2 kg to about 4.0 kg of methane-rich gas per 1 kg of high purity hydrogen gas stream 136 produced in the blue hydrogen unit 120.

In examples, one or more controllers may be used to control the flow of methane-rich gas stream 140. In examples, the flow of methane-rich gas stream 140 fed to the hydrogen synthesis system 122 for hydrogen production may be controlled via one or more valves. In examples, a portion of methane-rich gas stream 140 may be diverted to be used as fuel by hydrogen synthesis system 122. In examples, the flow of methane-rich gas stream 140 fed to the hydrogen synthesis system 122 to produce hydrogen may be controlled by varying the amount of methane-rich gas stream 140 diverted to be used as fuel for the hydrogen synthesis system 122. In examples, variation of the flow to the feed of the hydrogen synthesis system 122 may control the amount of methane-rich gas stream 140 diverted to be used as fuel for the hydrogen synthesis system 122. In examples, (not shown) a portion of the methane-rich gas stream 140 may be withdrawn and either stored or otherwise disposed. In examples, flow rate of the methane-rich gas stream 140 to be fed to the hydrogen synthesis system 122 for hydrogen production, and/or to be used as fuel for the hydrogen synthesis system 122 may be controlled by varying an amount withdrawn from methane-rich gas stream 140. Any combination of these controls that may be actuated by one or more controllers and valve systems may be implemented to control the flow of methane-rich gas stream 140 or a portion thereof to the feed of hydrogen synthesis system 122 for hydrogen production, to be used as fuel by the hydrogen synthesis system 122, or both.

In examples, an overall fuel gas balance to the steam cracking unit may dictate how the flow of methane-rich gas stream 140 is controlled. In examples, from the steam cracking unit 110, flow of methane-rich gas stream 140 to the blue hydrogen unit 120 may be controlled based on a hydrogen requirement of the blue hydrogen unit 120. For example, if the system detects a surplus of hydrogen source, then the excess methane-rich gas stream 140 may be redirected to export. If, however, the system detects a deficit of hydrogen supply, then more or all of the methane-rich gas stream 140 may be directed to the hydrogen synthesis system 122 to be used for hydrogen production. In examples, if a deficit is still detected after directing the full methane-rich gas stream 140 to the hydrogen synthesis system 122 for hydrogen production, then external natural gas feed 128 may be increased.

In examples, the methane-rich gas stream 140 to be used as feed to the hydrogen synthesis system 122 to produce hydrogen may be compressed. In examples, the integration system 100 may include compressing the methane-rich gas stream 140 to a desired blue hydrogen unit 120 feed gas pressure. In examples, the methane-rich gas stream 140, or a portion thereof, may be compressed to a pressure of about 20 barg to about 40 barg. In examples, the system 100 may include a compressor 180. In examples, compressor 180 may include a gas compressor. In examples, the compressor 180 may be electrically powered. In examples, at least a portion of the methane-rich gas stream 140 may be compressed by compressor 180 prior to reaching the blue hydrogen unit 120. In examples, at least a portion of the methane-rich gas stream 140 may be compressed by compressor 180 prior to being fed to the hydrogen synthesis system 122 of the blue hydrogen unit 120 for hydrogen production. In examples, the methane-rich gas stream 140, or a portion thereof, that is fed to the hydrogen synthesis system 122 together with or as natural gas feed 128 may be compressed by compressor 180 prior to being fed to the hydrogen synthesis system 122 for hydrogen production. In examples, the portion of methane-rich gas stream 140 that may be directed to the hydrogen synthesis system 122 to be used as fuel to generate heat may not be compressed.

In examples, the hydrogen-rich gas stream 142 may be used as fuel for the cracking furnace 112. In examples, the hydrogen-rich gas stream 142 may be supplemented by at least a portion of the effluent stream 134 from the carbon capture system 124a. In examples, the hydrogen-rich gas stream 142 may be supplemented by at least a portion of the high purity hydrogen gas stream 136.

However, using as fuel for cracking furnace 112 a hydrogen stream that includes some methane may result in some carbon emission in the flue gas of the cracking furnace 112. In examples, a higher purity hydrogen stream may be desirable to use as fuel in the cracking furnace 112 to diminish and/or eliminate the carbon emission.

In examples, to yield a higher purity hydrogen stream to feed as fuel to the cracking furnace 112, the integration 100 may include exporting all or at least a portion of hydrogen-rich gas stream 142 from the steam cracking unit 110 to the blue hydrogen unit 120. In examples, the integration 100 may include exporting all or at least a portion of hydrogen-rich gas stream 142 from the recovery system 114 of the steam cracking unit 110 to the blue hydrogen unit 120.

In examples, all or at least a portion of the hydrogen-rich gas stream 142 from the recovery system 114 of the steam cracking unit 110 may be injected upstream of the hydrogen recovery system 126. In examples, the hydrogen-rich gas stream 142 may be injected immediately upstream of the hydrogen recovery system 126. In examples, where the hydrogen recovery system 126 includes a PSA, the hydrogen-rich gas stream 142 may be injected upstream of the PSA, for example, immediately upstream of the PSA of the blue hydrogen unit 120. In examples, all or at least a portion of the hydrogen-rich gas stream 142 may be combined with effluent stream 134 from the carbon capture system 124a of the blue hydrogen unit 120 ahead of the PSA or other hydrogen recovery system 126.

In examples, the integration may include importing high purity hydrogen gas from the blue hydrogen unit 120 to the steam cracking unit 110. In examples, at least a portion of high purity hydrogen gas stream 136 produced by blue hydrogen unit 120 may be used as fuel for cracking furnace 112. In examples, at least a portion of high purity hydrogen gas stream 136 produced by blue hydrogen unit 120 may be used as the only fuel to combine with combustion air for producing heat in cracking furnace 112. In examples, at least a portion of high purity hydrogen gas stream 136 produced by blue hydrogen unit 120 may be used as part of the fuel for cracking furnace 112. In examples, a portion of high purity hydrogen gas stream 136 may be collected at 152. In examples, another portion of high purity hydrogen gas stream 136 may be directed to the cracking furnace 112 to be used as fuel. In examples, a portion of high purity hydrogen gas stream 136 may be directed to the cracking furnace 112 to be used as the only fuel for the cracking furnace 112. In examples, not shown, a portion of high purity hydrogen gas stream 136 may be combined with at least a portion of hydrogen-rich gas stream 142 and fed to the cracking furnace 112.

In examples, the high purity hydrogen gas imported into the steam cracking unit 110 from the blue hydrogen unit 120 may originate at least in part from hydrogen-rich gas stream 142, the hydrogen produced from methane-rich gas stream 140 in the hydrogen synthesis system 122, or a combination thereof.

In examples, prior to directing the high purity hydrogen gas stream 136 to cracking furnace 112 as fuel, it may be desirable to adjust the pressure of the stream based on the cracking furnace 112 fuel gas back-pressure. In examples, the pressure of the high purity hydrogen gas stream 136 may be adjusted to range from about 3 barg to about 8 barg. In examples, the pressure of high purity hydrogen gas stream 136 may be adjusted using an expander 190. In examples, expander 190 may include a turbo-expander. In examples, expander 190 may be configured to recover energy, such as electrical energy, from the expansion of the high purity hydrogen gas stream 136. In examples, the recovered energy may be used for any suitable application. In examples, the energy recovered from the expander 190 may be used, at least in part, to power at least in part the compressor 180. In examples, the expander 190 may be employed to drive the compressor 180 in a direct-coupled arrangement. In examples, the power to compressor 180 may be from a source other than expander 190.

In examples, the integration may optionally include preheating at least a portion of the high purity hydrogen gas stream 136. In examples, at least the portion of high purity hydrogen gas stream 136 that is imported into the steam cracking unit 110 to use as fuel for the cracking furnace may be preheated. In examples, the system 100 may include a heater 170. In examples, heater 170 may be an electric heater, a heat exchanger, a low-pressure steam heater, or any combination thereof. In examples, heater 170 may be upstream of the expander 190. In examples, heater 170 can be configured to heat at least a portion of the high purity hydrogen gas stream 136 prior to it entering the expander 190. In examples, by heating the high purity hydrogen gas stream 136 before the pressure reduction by expander 190 may increase or maximize power recovery. In examples, the target preheat amount of the high purity hydrogen gas stream 136 may be set so as to achieve an expander outlet temperature near ambient temperature. In examples, the imported high purity hydrogen gas stream 136 or at least the portion thereof that is directed to the steam cracking unit 110 may be preheated to a temperature of about 120-150° C., for examples, about 140° C.

In examples, the steam cracking unit 110 may receive a feed 154 and a stream of combustion air 156. In examples, the steam cracking unit 110 may crack hydrocarbons to produce olefins. In examples, the product output stream 158 of steam cracking unit 110 is directed to recovery system 114. In examples, after separating the methane-rich gas stream 140 and the hydrogen-rich gas stream 142 from product output stream 158, the recovery system 114 may output a olefins stream 160. In examples, recovery system 114 may output one or more by product streams 162. In examples, by using high purity hydrogen gas stream 136 as fuel in steam cracking unit 110, off-gas stream 164 of steam cracking unit 110 may include little to no CO.

In examples, one or more lines, pipes and/or conduits may be used to fluidly connect the steam cracking unit 110 to the blue hydrogen unit 120. In examples, one or more valves, not shown, may be included to control the flow through the one or more lines, pipes and/or conduits. In examples, one or more pipes, lines, and/or conduits may be used to direct or transfer one or more streams, feeds, or effluents between the steam cracking unit 110 and the blue hydrogen unit 120.

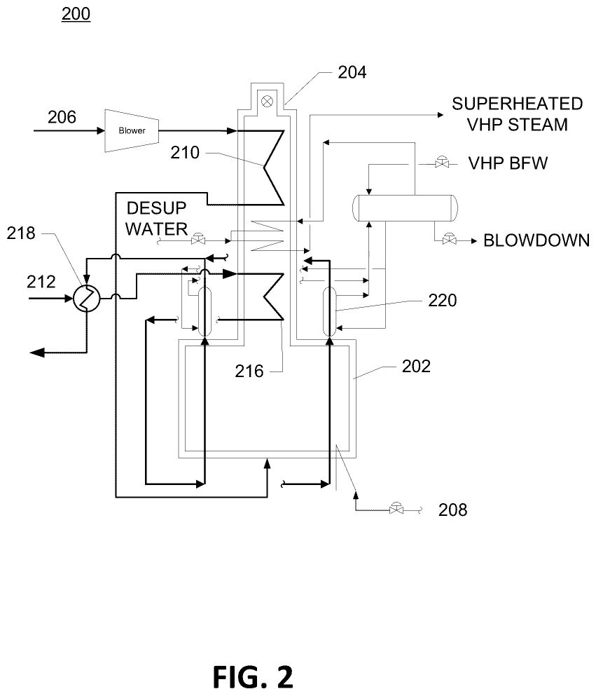

In examples, the integration 100 as described may be implemented with a steam cracking unit 110 in which the cracking furnace 112 may include a gas feed or a liquid feed. An example cracking furnace with gas feed is illustrated in FIG. 2.

In examples, a steam cracking unit 110 may include a cracking furnace 200 having a gas feed as, for example, shown in FIG. 2. In examples, the cracking furnace 200 may include a radiant section 202 and a convection section 204. A source of combustion air 206 may be used together with a fuel gas 208 as a combustion mixture for the radiant section 202 of the furnace. In examples, the combustion air may be pre-heated. In examples, the pre-heating of the combustion air may be accomplished using a heater 210 that recovers heat from a flue gas in the convection section 204 of the cracking furnace 200. In examples, a hydrocarbon gas feed 212 may be fed to one or more reaction tubes 214 provided in the radiant section 202 of the cracking furnace 200. In examples, the feed 212 may be preheated prior to feeding it to the one or more reaction tubes 214. In examples, the feed 212 may be pre-heated via a heater 216 that recovers heat from the convection section of the furnace, via a feed/effluent heat exchanger 218 that transfers heat from an effluent cracked gas to the feed 212, or a combination thereof. In examples, the cracking reaction may occur in one or more reaction tubes 214. In examples, the cracking reaction may produce an effluent cracked gas. In examples, the effluent cracked gas may contain methane, hydrogen, and one or more olefins. In examples, the effluent cracked gas may be cooled by one or more quenchers 220. In examples, the fuel gas 208 may include a hydrogen-rich gas stream or a high purity hydrogen gas stream.

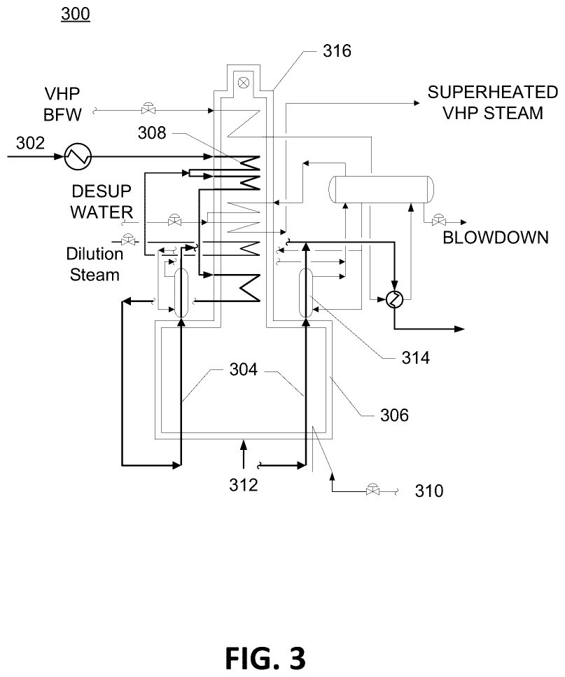

In examples, as illustrated in FIG. 3, the steam cracking unit 110 may include a cracking furnace 300 with liquid feed. As illustrated in FIG. 3, the cracking furnace 300 of the steam cracking unit may include a liquid naphtha feed (LN Feed) 302. In examples, as shown, the liquid feed 302 may be pre-heated prior to entering one or more reaction tubes 304 in the radiant section 306 of the cracking furnace 300. In examples, one or more heater 308 may be used to preheat the feed to vaporize the feed prior to injection into the one or more reaction tubes 304. In examples, the one or more heaters 308 may be configured to recover flue gas heat from convection section 316 of the cracking furnace. In examples, a fuel gas 310 and combustion air 312 may be fed to the radiant section 306 of cracking furnace 300 for combustion and heat generation. One or more quenchers 314 may be used to quench an effluent cracked gas of furnace 300.

In examples, the steam cracking unit 110 may include a recovery system 114 and process in which effluent cracked gas may be processed to further segregate the methane, olefins, and hydrogen. In examples, the process may yield a hydrogen-rich gas stream, an olefins stream, and a methane-rich gas stream.

In examples, the cracking furnace design may include one or more burners in capable of burning 100% pure hydrogen.

In examples, the cracking furnace may use high purity hydrogen as fuel gas to achieve net zero CO2 emission from the furnaces. In examples, high purity hydrogen may be the only fuel gas other than combustion air. In examples, the combustion air is free or substantially free (i.e. no more than trace amount or 1 mol % or less) of hydrocarbons.

In examples, the cracking furnace design may use one or more of features to provide the most capital and energy-efficient solution to achieve the lowest overall carbon emission.

In examples, the combustion air may be preheated to minimize the furnace fired duty and associated import hydrogen required. In examples, the feed to the cracking furnace may be preheated. In examples, both the combustion air and the feed may be preheated. In examples, the combustion air may be preheated by recovering heat from the convection section of the cracking furnace, by heat exchanger, one or more electronic heaters, or any combination thereof. In examples, the hydrocarbon feed to the cracking furnace may be preheated via one or more heat exchangers, against the cracking furnace effluent gas, by recovering heat from the convection section of the cracking furnace, by one or more electric heaters, or any combination thereof. In examples, a liquid naphtha feed may be heated to produce a gas feed prior to entering the one or more reactor tubes of the cracking furnace.

In examples, the combustion air may be preheated to a temperature of about 400° C. to about 450° C. or to about 650° C. to about 750° C. In examples, the hydrocarbon feed stream to the cracking furnace may be preheated to about 620° C. to about 640° C. prior to introducing it into the one or more reactor tubes of the cracking furnace.

In examples, the cracking furnace may be configured to apply a combustion air preheat design as for example disclosed in co-pending U.S. application Ser. No. 17/880,973, filed on Aug. 4, 2022, entitled “Low CO2 emission Ethane Cracker”, which is incorporated herein by reference in its entirety. In examples, the cracking furnace may be configured to preheat combustion air as for example described in co-pending U.S. Application No. 63/516,104, filed on Jul. 27, 2023, entitled “Net Zero Ethane Cracker with no External Hydrogen Import”, incorporated herein by reference in its entirety. In examples, the cracking furnace may be configured to preheat the hydrocarbon feed and/or combustion air as for example described in co-pending U.S. Application No. 63/516,066, filed on Jul. 27, 2023, entitled “100% Hydrogen-Fired Liquid Cracking Furnace”, incorporated herein by reference in its entirety.

As illustrated in FIG. 1 and, for example, as discussed in co-pending U.S. application Ser. No. 17/880,973, the steam cracking unit may include a recovery system 114 to recover a methane-rich gas stream, a hydrogen-rich gas stream, and an olefins stream.

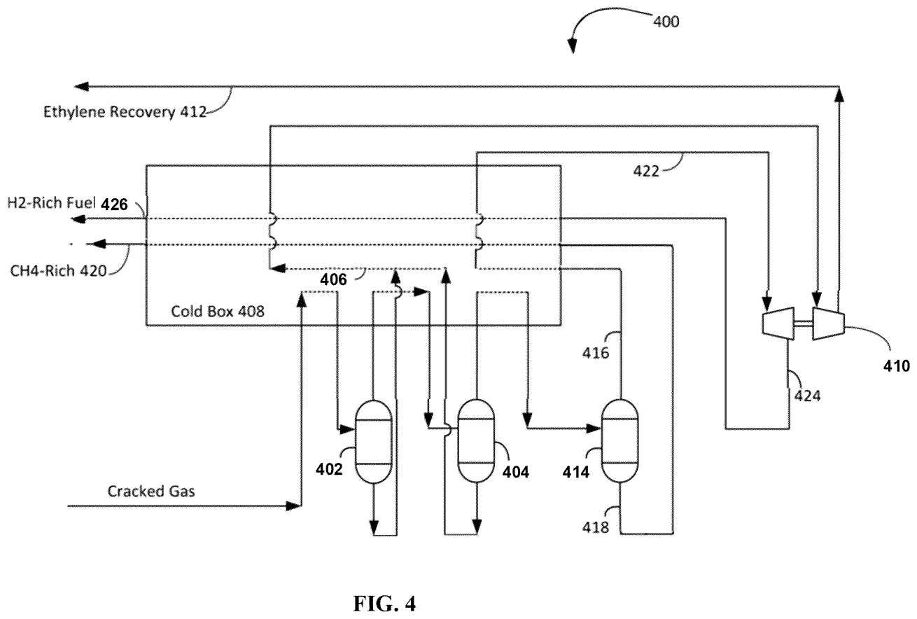

FIG. 4 illustrates an example of recovery system 114. FIG. 4 is only exemplary and other recovery system designs may also be employed.

FIG. 4 illustrates an example of a recovery system 114. In examples, the recovery system 114 may be configured as system 400. In examples, system 400 may be implemented for an ethane cracking process. The cracked gas process stream from the cracking furnace may include hydrogen, methane, and ethylene. In examples, the cracked gas process stream may enter the illustrated process, for example, at a temperature of about −73° C. The temperatures and pressures in this description of system 400 are only illustrative of a particular embodiment of the process. In examples, the temperatures/pressures may be varied. The cracked gas process stream may be cooled in the cold box 408. In examples, cold box 408 may include other hot and cold lines not illustrated here.

In examples, a light fraction of the cracked gas process stream from cracking furnace 112 may be progressively cooled and passed through knock-out drums 402 and 404 to separate out ethylene. In examples, the light fraction of the cracked gas process stream from cracking furnace 112 may include hydrogen, methane, carbon monoxide, ethylene, ethane, or any combination thereof. The cooling temperatures can be configured to manage the approach temperatures in the cold box. According to some embodiments, the temperature of the first knock-out drum 402 may be about −115° C.±10° C. and the temperature of the second knock-out drum may be about −130 to about −145° C. The bottom streams of the knock-out drums 402 and 404, which are enriched in ethylene, can be combined into an ethylene-rich stream 406. The ethylene-rich stream 406 can be recompressed using a turbo expander/compressor 410 to provide an ethylene-rich ethylene recovery stream 412.

In examples, the top streams of the knock-out drums 402 and 404, which are enriched in methane and hydrogen can be further cooled in the cold box and provided to a third knock-out drum 414. In examples, the temperature of the third knock-out drum 414 may be about −163° C.±10° C. The top stream 416 from the third knock-out drum 414 is enriched in hydrogen. The bottom stream 418 from the third knock-out drum 414 is enriched in methane. The temperature of the third knock-out drum 414 may determine how much methane is knocked out, i.e., it can determine the purity of the hydrogen stream.

In examples, the methane-enriched bottom stream 418 may be reheated in the cold box and then exits the system as a methane-rich gas stream 420.

The hydrogen-enriched top stream 416 may be reheated in the cold box to provide a reheated hydrogen-enriched stream 422. In examples, the temperature of the reheated hydrogen-enriched stream 422 can be about −140° C. and its pressure can be about 20 to about 45 barg.

In examples, where the hydrogen-rich gas stream ultimately output from recovery system 114 or 400 is to be used as fuel for the cracking furnace of the steam cracking unit from where the hydrogen gas is being recovered, the hydrogen-enriched stream 422 may be expanded using the turbo expander/compressor 410 to yield an expanded hydrogen-enriched stream 424. In examples, the expansion may lead to a drop in the temperature and pressure of the expanded hydrogen-enriched stream 424. For example, post expansion, the temperature of hydrogen-enriched stream 424 may be about −177° C. and the pressure may be less than about 10 barg, for example about 6 barg. In examples, the expanded hydrogen-enriched stream 424 may be reintroduced to the cold box 408, thereby providing a cold stream within the cold box capable of providing an adequate temperature approach to effect the separation of methane and hydrogen in the knock-out drum 414. The expanded hydrogen-enriched stream 424 may ultimately exit the cold box as hydrogen-rich gas stream 426.

In examples, where the hydrogen-rich gas stream ultimately output from recovery system 114 or 400 is to be directed to the blue hydrogen unit 120 for further purification, then the hydrogen enriched top stream 416 from drum 414 may be kept at pressure. In examples, the hydrogen enriched top stream 416 may just be reheated and sent to the blue hydrogen unit 120 to be combine with effluent stream 134 ahead of hydrogen recovery system 126. In examples, no expansion of the hydrogen enriched top stream 416 would be performed. To still provide a stream cold enough to provide cooling needed in the coldest section of the cold box to achieve the target conditions in drum 414, in examples, prior to directing the hydrogen enriched top stream 416 to the blue hydrogen unit 120, a portion, for example about 10-15%, of the hydrogen enriched top stream 416 may be split off and mixed with methane-enriched bottom stream 418 before being reheated in the cold box. In this manner, it may be possible to lower the vaporization temperature of the methane-enriched bottom stream 418 and thus enabling it to provide the desired temperature approach.

In examples, the hydrogen-rich gas stream 426 may comprise greater than 90 mol % hydrogen, or greater than 95 mol % hydrogen, with most of the remainder comprising methane. In examples, the system 400 may recover over 90% or over 95% of the hydrogen available in the cracked gas process stream.

In examples, the methane-rich gas stream and the hydrogen-rich gas stream exiting the recovery system 114 of steam cracking unit 110 are the methane-rich gas stream 140 and the hydrogen-rich gas stream 142 that may be directed to the blue hydrogen unit 120 of the integrated system 100.

In examples, the process and system as described may include one or more of selective use of electric drivers for major compressors in recovery section to achieve a neutral or net export steam balance for the combined steam cracking unit 110 and blue hydrogen unit 120, and use of green imported power with no associated CO2 emissions.

In examples, the systems described herein including the system and process as integrated may include one or more control systems, sensors, and other standard components that allows for the control and operation thereof.

In examples, although not shown, the systems described herein may include one or more sensors as generally employed in the art. In examples, sensors may be used to monitor the operation of the systems described. Non-limiting examples of one or more sensors may include temperature sensors, pressure sensors, flow meters, and other like sensors.

In examples, although not shown, the one or more control systems may include one or more controllers and/or other suitable computing devices may be employed to control one or more of portions of systems described herein. Controllers may include one or more processors and memory communicatively coupled with each other. In the illustrated example, a memory may be used to store logic instructions to operate and/or control and/or monitor the operation of one or more components of the system described. In examples, the controllers may include or be coupled to input/output devices such as monitors, keyboards, speakers, microphones, computer mouse and the like. In examples, the one or more controllers may also include one or more communication components such as transceivers or like structure to enable wired and/or wireless communication. In examples, this may allow for remote operation of one or more systems described herein.

In examples, memory associated with the one or more controllers and/or other suitable computing devices may be non-transitory computer-readable media. The memory may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The controls systems may include any number of logical, programmatic, and physical components.

Logic instructions may include one or more software modules and/or other sufficient information for autonomous operation, safety procedures, and routine maintenance processes. Any operation of the described system may be implemented in hardware, software, or a combination thereof. In the context of software, operations represent computer-executable instructions stored on one or more computer-readable storage media that, when executed by one or more processors, perform the recited operations. Generally, computer-executable instructions include routines, programs, objects, components, data structures, and the like that perform one or more functions or implement particular abstract data types.

In examples, integration of a steam cracking unit with a blue hydrogen unit as described can provide one or more benefits. In examples, integration can reduce and/or minimize combined unit capital cost by sharing equipment (for example a shared PSA of the blue hydrogen unit). In examples, the integration can reduce and/or minimize combined unit capital cost through increased and/or maximum utilization of internally produced hydrogen and/or increased and/or maximum air preheat on the furnaces. This may reduce and/or minimize the net hydrogen required from the blue hydrogen unit. In examples, the integration can reduce and/or minimize net hydrogen required to reduce the CO2 produced in blue hydrogen unit that would otherwise have to be captured and/or stored. In examples, an efficient integration of feed and product streams can reduce the combined unit energy consumption.

Example of Integration with Ethane Steam Cracking Unit

The features and benefits of the process and system as described can be highlighted by comparing to a base case example that assumes the use of KBR's SCORE® SC-1 short residence time furnace technology that includes a single pass radiant-coil design with feed entering the bottom and cracked gas leaving the top of the furnace radiant section. It is noted that the SC-1 was selected for illustration purposes only. The integration as described can also be applied using other coil types and is not limited to SC-1.

To illustrate the potential benefit of the integration, combustion air preheated to 425° C. was included for the case that uses high purity hydrogen. This reduced the fired duty by approximately 25% compared to the base case. In this example system, the cracking furnace convection section, the feed preheat, and the effluent cooling as discussed in co-pending U.S. application Ser. No. 17/880,973 were reconfigured with respect to relative duties for feed preheat and steam generation. In particular, the relative duties for feed preheat and steam generation were shifted due to change in heating value of pure hydrogen which can produce less flue gas, and thus provides less duty available for feed preheat and steam generation compared to case described in the copending application.

The table below shows an example calculation for an ethane cracker, comparing a conventional ethane cracker (base) and a net zero design with blue hydrogen unit integration.

| | | With H2 |
|---|---|---|
| | | Import |
| Balances for 1800 KTA Cracker | Base | (Net Zero) |
| Ethylene Production, KTA | 1800 | 1800 |
| Furnace Fired Duty, Gcal/h (max APH for low | 737.0 | 547.5 |
| & net Zero cases) | | |
| Fuel Gas to furnaces, kg/h | 39318 | 19111 |
| | (85 mol% | (100% |
| | H2) | H2) |
| PSA H2 recovered from cracker effluent, kg/h | | 16553 |
| Net amount of H2 produced from methane in | | 2558 |
| H2 unit | | |
| Methane required to produce net H2, kg/h | | 9629 |
| Scope 1 Emissions | | |
| CO2 emission from furnaces to ATM, kg/h | 63666 | |
| CO2 emission from H2 unit to ATM, kg/h | | 225 |
| Total Direct CO2 emission, kg CO2/kg | 0.297 | 0.001 |
| Ethylene | | |
| CO2 from H2 unit—captured and stored, kg/h | | 22506 |

The table below shows results when imported power is based on grey power (fossil fuel based) or green power (no associated CO2 emissions).

| | | With H2 |
|---|---|---|
| | | Import |
| Preliminary Balance for 1800 KTA Cracker | Base | (Net Zero) |
| Ethylene Production, KTA | 1800 | 1800 |
| Steam Import (Export)—Cracker + H2 unit, kg/h | 3977 | (44357) |
| Power import—Cracker + H2 unit, kWh | 8886 | 71980 |
| Direct Emission—Furnaces & H2 unit, kg/h | 63666 | 225 |
| Indirect Emission—Steam import (export), kg/h | 593 | (6609) |
| Indirect Emission—Grey Power, kg/h | 3341 | 27065 |
| Total Emissions (grey power), kg/h | 67600 | 20681 |
| Total Emissions (grey power), kg CO2/kg C2═ | 0.315 | 0.097 |
| Total Emissions (green power), kg/h | 64259 | −6384 |
| Total Emissions (green power), kg CO2/kg C2═ | 0.300 | −0.03 |

The application of maximum air preheat allowed a significant reduction in furnace fired duty and associated net hydrogen import needed. With the integration between the steam cracker unit and blue hydrogen unit it is possible to utilize near 100% of the hydrogen produced in the cracking furnace as fuel for the cracking furnaces, while hydrogen produced from methane-rich gas accounts for only about 14% of the cracking furnace duty demand. The integration makes it possible to achieve net zero total emission (assuming green power is available) with a relatively small blue hydrogen unit.

Example of Integration with Liquid Feed Cracker

In the example below, the base case uses tail gas (methane-rich) fuel gas and a conventional arrangement where feed vaporization, dilution steam (DS) superheating and mixed feed superheating occurs in the convection section. The base case example assumes the use of KBR's SCORE® SC-1 short residence time furnace technology that includes a single pass radiant-coil design with feed entering the bottom and cracked gas leaving the top of the furnace radiant section.

To illustrate the potential benefit of the invention, Case 1 uses pure hydrogen as fuel gas, and also includes combustion air preheat to 450° C.

The example is based on cracking light naphtha, with an overall unit capacity of 1000 KTA (ethane and propane recycled to extinction).

| | UOM | Base | Case 1 |
|---|---|---|---|
| Furnace Utility Balance | | | |
| SHP Steam Generation | % of Base | 100% | 53% |
| Fired Duty | % of Base | 100% | 72% |
| Site Fuel Gas Balance | | | |
| Net available tail gas | kg/h | 55200 | 53990 |
| Tail gas consumed in furnaces | kg/h | 50319 | 0 |
| Pure H2 consumed in furnaces | kg/h | 0 | 15689 |
| Methane-rich gas consumed in H2 unit | kg/h | 0 | 51323 |
| NG import/(tail gas export) | kg/h | −4880 | −2667 |
| H2 Plant Balance | | | |
| Net H2 Import Required* | kg/h | | 13632 |
| Steam export | kg/h | | 49634 |
| Power import | kW | | 3463 |
| Natural gas Import | kg/h | | 51323 |
| CO2 Captured | kg/h | | 118761 |
| CO2 to atm | kg/h | | 1200 |

*Adjusted to exclude offsets from internal H2 available

### Power Import (Export) for Neutral Steam Balance

| | | | |
|---|---|---|---|
| Power Equivalent (Electric) | kW | 3892 | 51016* |

*Would require partial electrification of major compressors

| | UOM | Base | Case 1 |
|---|---|---|---|
| CO2 from Furnaces to atm | kg/h | 135163 | 361 |
| CO2 from H2 plant to atm | kg/h | | 1200 |
| CO2 to atm | kg/h | 135163 | 1561 |

The use of combustion air preheat reduced the cracking furnace fired duty by approximately 25%, which significantly reduced the external hydrogen import requirement. This also significantly reduced the steam generation on the cracking furnace, so it was assumed that the shortfall in the steam balance would be offset by switching one of the major compressors in the recovery system to electric drive.

Liquid cracking may not produce a lot of hydrogen, and some hydrogen may also be required for gasoline hydrotreating, which was considered in determining the net amount of hydrogen available from the steam cracker. In this case, 87% of the hydrogen used as fuel was produced in the hydrogen unit, with only 13% originating from steam cracking. On the assumption that electric power supply is green, it may be possible to achieve near zero emission from the liquid cracker. On an overall basis, there may be little change in the fuel gas balance-Case 1 has a small surplus of methane-rich tail gas, slightly smaller than the Base Case.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system comprising:
a steam cracking unit;
a blue hydrogen unit comprising a hydrogen recovery system configured to generate a high purity hydrogen gas stream;
a first conduit configured to direct at least a portion of the high purity hydrogen gas stream to the steam cracking unit to be used as fuel; and
a second conduit configured to direct at least a portion of a methane-rich gas stream from the steam cracking unit to the blue hydrogen unit.

2. The system of claim 1, wherein the steam cracking unit comprises a cracking furnace and a recovery stage configured to recover
the methane-rich gas stream from an effluent gas of the cracking furnace of the steam cracking unit and further comprising a second conduit configured to direct at least a portion of the methane-rich gas stream to the blue hydrogen unit to be used as feed, fuel, or both.

3. The system of claim 2, further comprising a compressor configured to compress at least a portion of the methane-rich gas stream prior to reaching the blue hydrogen unit.

4. The system of claim 1, further comprising:
a recovery stage as part of the steam cracking unit configured to receive an effluent from a cracking furnace and separate from the effluent at least a hydrogen-rich gas stream and a methane-rich gas stream; and
a third conduit configured to transfer at least a portion the hydrogen-rich gas stream from the recovery stage to the hydrogen recovery system of the blue hydrogen unit.

5. The system of claim 1, further comprising a gas expander for expanding the high purity hydrogen gas stream before it reaches the steam cracking unit.

6. The system of claim 5, further comprising a heater for preheating the high purity hydrogen gas stream before it reaches the gas expander.

7. The system of claim 5, further comprising a compressor configured to compress at least a portion of the methane-rich gas stream prior to reaching the blue hydrogen unit, wherein an energy recovered by the gas expander is employed to power the compressor.

8. A process comprising:
generating a high purity hydrogen gas stream in a blue hydrogen unit comprising a hydrogen recovery system;
feeding the high purity hydrogen gas stream to a steam cracking unit as fuel; and
directing a methane-rich gas stream from the steam cracking unit to the blue hydrogen unit.

9. The process of claim 8, further comprising:
recovering the methane-rich gas stream from an effluent of the steam cracking unit; and
directing the methane-rich gas stream to the blue hydrogen unit as feed, fuel, or both.

10. The process of claim 9, wherein the steam cracking unit comprises a cracking furnace, further comprising:
recovering a hydrogen-rich gas stream from the tail gas of the cracking furnace of the steam cracking unit; and
transferring at least a portion of the recovered hydrogen-rich gas stream to the hydrogen recovery system of the blue hydrogen unit.

11. The process of claim 9, further comprising compressing the methane-rich gas stream prior to directing the methane-rich gas stream to the blue hydrogen unit.

12. The process of claim 8, further comprising expanding the high purity hydrogen gas stream before feeding the high purity hydrogen rich gas to the steam cracking unit.

13. The process of claim 11, further comprising preheating the high purity hydrogen gas stream before expanding it.

14. The process of claim 11, further comprising recovering energy when expanding the high purity hydrogen gas stream.

15. The process of claim 14, further comprising compressing a methane-rich gas stream from the steam cracking unit using a compressor and powering said compressor with the energy recovered from expanding the high purity hydrogen gas stream prior to directing the methane-rich gas stream to the blue hydrogen unit.

16. The process of claim 8, wherein the steam cracking unit comprises a cracking furnace and further comprising preheating a combustion air used as fuel in a cracking furnace of the steam cracking unit.

17. The process of claim 8, wherein the steam cracking unit comprises a cracking furnace and further comprising preheating a feed to a cracking furnace of the steam cracking unit.
